(19) United States
(12) Patent Application Publication
(10) Pub. No.: US 2026/0279850 A1
(43) Pub. Date: Sep. 17, 2026

(54) ELECTROCHEMICAL CELL AND SEPARATOR-EQUIPPED ELECTROCHEMICAL CELL

(71) Applicant: NGK Corporation, Nagoya-shi, Aichi (JP)

(72) Inventors: Yusuke EDANO, Nagoya-shi (JP); Kazuhiro MIZUKI, Kuwana-shi (JP); Shinji FUJISAKI, Kuwana-shi (JP); Makoto OHMORI, Nagoya-shi (JP)

(21) Appl. No.: 19/673,365

(22) Filed: May 11, 2026

Related U.S. Application Data
(63) Continuation of application No. PCT/JP2023/040979, filed on Nov. 14, 2023.

(51) Int. Cl. H01M 8/0273; H01M 8/0206; H01M 8/0282

(52) U.S. Cl. CPC H01M 8/0273; H01M 8/0206; H01M 8/0282

(57) ABSTRACT

An electrochemical cell is connectable to a metal separator. The electrochemical cell includes a cell body portion including a current collector layer, a first electrode layer disposed on the current collector layer, a second electrode layer, and an electrolyte layer disposed between the first electrode layer and the second electrode layer, and an annular support frame configured to be connectable to the metal separator and surrounding at least a portion of the cell body portion. The support frame contains zirconia and nickel oxide. A porosity of the support frame after a reduction treatment at 750° C. for 12 hours is 15% or less.

### CROSS-REFERENCE TO RELATED APPLICATION

This is a continuation of PCT/JP2023/040979, filed Nov. 14, 2023, the entire contents of which are hereby incorporated by reference.

### TECHNICAL FIELD

The present invention relates to an electrochemical cell and a separator-equipped electrochemical cell.

### BACKGROUND ART

Conventionally, a solid electrolyte type electrochemical cell having a cell body portion constituted by an electrolyte layer disposed between a first electrode layer and a second electrode layer is known (for example, see JP 2016-58382A). Examples of electrochemical cells include an electrolytic cell and a fuel cell. The fuel cell described in JP 2016-58382A is a so-called electrode support type cell, in which the first electrode layer is formed thicker than the electrolyte layer, and the electrolyte layer is connected to a separator.

### SUMMARY

However, since the thermal expansion coefficients of the cell body portion and the separator made of metal are different from each other, it has been difficult to maintain good connection between the cell body portion and the separator. This problem arises regardless of whether the fuel cell is an electrode support type cell or not, and also occurs generally in electrochemical cells other than a fuel cell.

An issue addressed by the present invention is to provide an electrochemical cell and a separator-equipped electrochemical cell which can keep a good connection with a metal separator.

An electrochemical cell according to a first aspect of the present invention is an electrochemical cell to be connectable to a metal separator, the electrochemical cell including a cell body portion including a current collector layer, a first electrode layer disposed on the current collector layer, a second electrode layer, and an electrolyte layer disposed between the first electrode layer and the second electrode layer, and an annular support frame configured to be connectable to the metal separator and surrounding at least a portion of the cell body portion. The support frame contains zirconia and nickel oxide. A porosity of the support frame after a reduction treatment at 750° C. for 12 hours is 15% or less.

An electrochemical cell according to a second aspect of the present invention is the electrochemical cell according to the first aspect, wherein a strength of the support frame after the reduction treatment is 140 MPa or more.

An electrochemical cell according to a third aspect of the present invention is the electrochemical cell according to the first or second aspect, wherein the support frame further contains magnesium oxide.

An electrochemical cell according to a fourth aspect of the present invention is the electrochemical cell according to any one of the first to third aspects, wherein the support frame contains at least one of 3YSZ and 4YSZ as zirconia.

An electrochemical cell according to a fifth aspect of the present invention is the electrochemical cell according to any one of the first to fourth aspects, wherein a difference between a thermal expansion coefficient of the support frame and a thermal expansion coefficient of the metal separator after the reduction treatment is 2.5 ppm/K or less.

An electrochemical cell according to a sixth aspect of the present invention is the electrochemical cell according to any one of the first to fifth aspects, wherein the support frame after the reduction treatment has a plurality of pores; and the plurality of pores have an average circle equivalent diameter of 5 μm or less.

A separator-equipped electrochemical cell according to a seventh aspect of the present invention includes the electrochemical cell according to any one of the first to sixth aspects; and a metal separator connected to the support frame.

According to the present invention, an electrochemical cell and a separator-equipped electrochemical cell which can keep a good connection with a metal separator can be provided.

### BRIEF DESCRIPTION OF DRAWINGS

FIG. 1 is a cross-sectional view of a separator-equipped electrolytic cell according to an embodiment.

FIG. 2 is a cross-sectional view of a separator-equipped electrolytic cell according to Variation 2.

FIG. 3 is a cross-sectional view of the separator-equipped electrolytic cell according to Variation 2.

### DESCRIPTION OF EMBODIMENTS

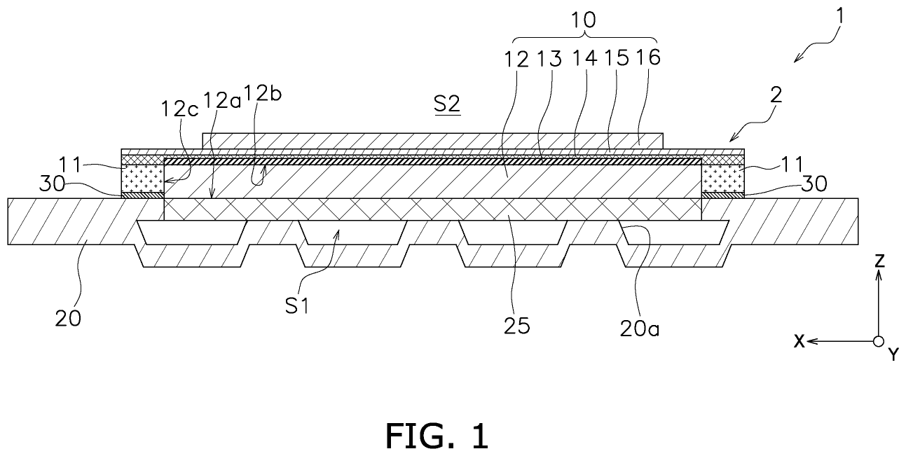

FIG. 1 is a cross-sectional view of a separator-equipped electrolytic cell 1 according to an embodiment. The separator-equipped electrolytic cell 1 is an example of the “separator-equipped electrochemical cell” according to the present invention.

The separator-equipped electrolytic cell 1 includes an electrolytic cell 2, a metal separator 20, a current collector member 25, and a bonding portion 30. The electrolytic cell 2 is an example of the “electrochemical cell” according to the present invention. A cell stack (not shown) can be formed by stacking a plurality of separator-equipped electrolytic cells 1 in the X-axis direction and the Z-axis direction perpendicular to the Y-axis direction.

### Electrolytic Cell 2

As shown in FIG. 1, the electrolytic cell 2 is connected to the metal separator 20 via the bonding portion 30.

The electrolytic cell 2 includes a cell body portion 10 and a support frame 11.

### Cell Body Portion 10

The cell body portion 10 is supported by the support frame 11. The cell body portion 10 is made of a ceramic material as will be described later. The thermal expansion coefficient of the cell body portion 10 is smaller than that of the metal separator 20. The thermal expansion coefficient of the cell body portion 10 is not particularly limited, and can be, for example, 10 ppm/K or more and 12 ppm/K or less.

The cell body portion 10 includes a hydrogen electrode current collector layer 12, a hydrogen electrode active layer 13, an electrolyte layer 14, a reaction prevention layer 15 and an oxygen electrode layer 16. The hydrogen electrode current collector layer 12 is an example of the “current collector layer” according to the present invention. The hydrogen electrode active layer 13 is an example of the “first electrode layer” according to the present invention. The oxygen electrode layer 16 is an example of the “second electrode layer” in the present invention.

The hydrogen electrode current collector layer 12, the hydrogen electrode active layer 13, the electrolyte layer 14, the reaction prevention layer 15 and the oxygen electrode layer 16 include: the layers are stacked in this order in the Z-axis direction. The hydrogen electrode current collector layer 12, the hydrogen electrode active layer 13, the electrolyte layer 14 and the oxygen electrode layer 16 are essential components, and the reaction prevention layer 15 is an optional component.

### Hydrogen Electrode Current Collector Layer 12

The hydrogen electrode current collector layer 12 has a plate shape. The hydrogen electrode current collector layer 12 has a first main surface 12a, a second main surface 12b, and a side surface 12c.

The first main surface 12a is provided on the opposite side to the hydrogen electrode active layer 13. The first main surface 12a is connected to the current collector member 25. The second main surface 12b is provided on the hydrogen electrode active layer 13 side. The first main surface 12a is connected to the hydrogen electrode active layer 13. The side surface 12c is continuous with the first main surface 12a and the second main surface 12b. The side surface 12c is formed along the Z-axis direction. The Z-axis direction is the thickness direction of the hydrogen electrode current collector layer 12. In the present embodiment, the side surface 12c is surrounded by the support frame 11.

The hydrogen electrode current collector layer 12 is electrically connected to the metal separator 20 via the current collector member 25. A hydrogen electrode side space S1 is formed between the hydrogen electrode current collector layer 12 and the metal separator 20.

In addition to a current collecting function, the hydrogen electrode current collector layer 12 has a gas diffusion function of diffusing the source gas supplied into the hydrogen electrode side space S1 into the hydrogen electrode active layer 13.

The hydrogen electrode current collector layer 12 is a porous body having electron conductivity. The hydrogen electrode current collector layer 12 contains nickel (Ni). The Ni contained in the hydrogen electrode current collector layer 12 is basically present in the state of metal Ni during the operation of the electrolytic cell 2, but a part thereof may be present in the state of nickel oxide (NiO).

The hydrogen electrode current collector layer 12 contains ceramic in addition to nickel (Ni). The ceramic may have ionic conductivity. Examples of the ceramic that can be used include yttria (Y₂O₃), magnesia (MgO), ferric oxide (Fe₂O₃), zirconia (ZrO₂, including partially stabilized zirconia), yttria-stabilized zirconia (YSZ), calcia-stabilized zirconia (CSZ), scandia-stabilized zirconia (ScSZ), gadolinium-doped ceria (GDC), samarium-doped ceria (SDC), and a mixed material obtained by combining two or more of these.

The porosity of the hydrogen electrode current collector layer 12 is not particularly limited, but may be, for example, 20% or more and 40% or less.

The thickness of the hydrogen electrode current collector layer 12 is not particularly limited, but may be, for example, 150 μm or more and 1000 μm or less. The thickness of the hydrogen electrode current collector layer 12 may be larger than the thickness of each of the hydrogen electrode active layer 13, the electrolyte layer 14, the reaction prevention layer 15, and the oxygen electrode layer 16.

The method for forming the hydrogen electrode current collector layer 12 is not particularly limited, and tape molding, screen printing, casting molding, dry pressing and the like can be used.

### Hydrogen Electrode Active Layer 13

The hydrogen electrode active layer 13 functions as a cathode. The hydrogen electrode active layer 13 is disposed on the hydrogen electrode current collector layer 12. The hydrogen electrode active layer 13 is covered with the electrolyte layer 14.

Source gas is supplied to the hydrogen electrode active layer 13 through the hydrogen electrode current collector layer 12. In the present embodiment, the source gas contains at least H₂O.

When the source gas contains only H₂O, the hydrogen electrode active layer 13 generates H₂ from the source gas by the electrochemical reaction for water electrolysis shown in Formula (1) below.

$$Hydrogen electrode active layer 13 : {H}_{2} O + 2 {e}^{-} \to {H}_{2} + {O}^{2 -} \qquad ( 1 )$$

When the source gas contains CO₂ in addition to H₂O, the hydrogen electrode active layer 13 follows the co-electrolysis electrochemical reactions shown in Formulas (2), (3), and (4) below: H₂, CO, and O²⁻ are produced from source gases.

$$Hydrogen electrode active layer 13 : {CO}_{2} + {H}_{2} O + 4 {e}^{-} \to CO + {H}_{2} + 2 {O}^{2 -} \qquad ( 2 )$$

$${H}_{2} O electrochemical reaction : {H}_{2} O + 2 {e}^{-} \to {H}_{2} + {O}^{2 -} \qquad ( 3 )$$

$${CO}_{2} electrochemical reaction : {CO}_{2} + 2 {e}^{-} \to CO + {O}^{2 -} \qquad ( 4 )$$

The hydrogen electrode active layer 13 is a porous body with electron conductivity. The hydrogen electrode active layer 13 contains nickel (Ni). Ni functions as an electron-conducting material. In the case of co-electrolysis, Ni also functions as a thermal catalyst for accelerating thermal reaction between H₂ that is produced and CO₂ contained in the source gas to maintain a gas composition suitable for methanation, reverse aqueous gas shift reaction, or the like. Although Ni contained in the hydrogen electrode active layer 13 basically exists in the state of metal Ni during operation of the electrolytic cell 2, some of the Ni may exist in the state of nickel oxide (NiO).

The hydrogen electrode active layer 13 may have ion conductivity. The hydrogen electrode active layer 13 can be made of, for example, YSZ, CSZ, ScSZ, GDC, SDC, (La, Sr) (Cr, Mn)O₃, (La, Sr)TiO₃, Sr₂(Fe, Mo)₂O₆, (La, Sr)VO₃, (La, Sr)FeO₃, a mixed material obtained by combining two or more of these materials, or a composite of one or more of these materials and NiO.

The porosity of the hydrogen electrode active layer 13 is not particularly limited, and may be, for example, 20% or more and 40% or less. The thickness of the hydrogen electrode active layer 13 is not particularly limited, but may be, for example, 5 μm or more and 50 μm or less.

The method for forming hydrogen electrode active layer 13 is not particularly limited, and tape molding, screen printing, casting, dry pressing or the like can be used.

### Electrolyte Layer 14

The electrolyte layer 14 is disposed between the hydrogen electrode active layer 13 and the oxygen electrode layer 16. In the present embodiment, since the reaction prevention layer 15 is disposed between the electrolyte layer 14 and the oxygen electrode layer 16, the electrolyte layer 14 is disposed between the hydrogen electrode active layer 13 and the reaction prevention layer 15, and is connected to the hydrogen electrode active layer 13 and the reaction prevention layer 15.

The electrolyte layer 14 covers the hydrogen electrode active layer 13. As shown in FIG. 1, the electrolyte layer 14 preferably covers the entire surface of the hydrogen electrode active layer 13. The outer peripheral portion of the electrolyte layer 14 is disposed on the support frame 11.

The electrolyte layer 14 has a function of transmitting O²⁻ generated in the hydrogen electrode active layer 13 to the oxygen electrode layer 16 side. The electrolyte layer 14 is a dense body having ionic conductivity and not having electronic conductivity. The electrolyte layer 14 may be made of, for example, YSZ, GDC, ScSZ, SDC, or lanthanum gallate (LSGM).

The porosity of the electrolyte layer 14 is not particularly limited, but may be, for example, 0.1% or more and 7% or less. The thickness of the electrolyte layer 14 is not particularly limited, but may be, for example, 1 μm or more and 100 μm or less.

The method for forming the electrolyte layer 14 is not particularly limited, and tape molding, screen printing, cast molding, dry pressing, or the like can be used.

### Reaction Prevention Layer 15

The reaction prevention layer 15 is disposed between the electrolyte layer 14 and the oxygen electrode layer 16. The reaction prevention layer 15 is disposed on the opposite side to the hydrogen electrode active layer 13 with respect to the electrolyte layer 14. The reaction prevention layer 15 prevents constituent elements of the electrolyte layer 14 from reacting with constituent elements of the oxygen electrode layer 16 to form a layer having a large electric resistance.

The reaction prevention layer 15 is made of an ion conductive material. The reaction prevention layer 15 can be made of GDC, SDC, or the like.

The porosity of the reaction prevention layer 15 is not particularly limited, but may be, for example, 0.1% or more and 50% or less. The thickness of the reaction prevention layer 15 is not particularly limited, and may be, for example, 1 μm or more and 50 μm or less.

The method for forming the reaction prevention layer 15 is not particularly limited, and tape molding, screen printing, cast molding, a dry pressing method, or the like can be used.

### Oxygen Electrode Layer 16

The oxygen electrode layer 16 functions as an anode. The oxygen electrode layer 16 is disposed on the opposite side to the hydrogen electrode active layer 13 with respect to the electrolyte layer 14. In the present embodiment, since the reaction prevention layer 15 is disposed between the electrolyte layer 14 and the oxygen electrode layer 16, the oxygen electrode layer 16 is disposed on the reaction prevention layer 15. In a case where the reaction prevention layer 15 is not disposed between the electrolyte layer 14 and the oxygen electrode layer 16, the oxygen electrode layer 16 is disposed on the electrolyte layer 14.

The oxygen electrode layer 16 generates O₂ from O²⁻ transferred from the hydrogen electrode active layer 13 via the electrolyte layer 14, according to the chemical reaction of the following formula (5). The O₂ generated in the oxygen electrode layer 16 is released to an oxygen electrode side space S2.

$$Oxygen electrode layer 16 : 2 {O}^{2 -} \to {O}_{2} + 4 {e}^{-} \qquad ( 5 )$$

The oxygen electrode layer 16 is a porous body having ionic conductivity and electronic conductivity. The oxygen electrode layer 16 can be made of, for example, a composite material of one or more of (La, Sr)(Co, Fe)O₃, (La, Sr)FeO₃, La(Ni, Fe)O₃, (La, Sr)CoO₃, and (Sm, Sr)CoO₃ and an ion conductive material (e.g., GDC).

The porosity of the oxygen electrode layer 16 is not particularly limited, but may be, for example, 20% or more and 60% or less. The thickness of the oxygen electrode layer 16 is not particularly limited, and may be, for example, 1 μm or more and 100 μm or less.

The method for forming the oxygen electrode layer 16 is not particularly limited, and tape molding, screen printing, cast molding, dry pressing, or the like can be used.

### Support Frame 11

The support frame 11 supports the cell body portion 10. The support frame 11 is disposed between the cell body portion 10 and the metal separator 20. In the present embodiment, the support frame 11 is connected to the separator 20 via the bonding portion 30.

The support frame 11 is an annular member that surrounds at least a portion of the cell body portion 10. In the present embodiment, the support frame 11 surrounds the hydrogen electrode current collector layer 12 of the cell body portion 10. In a plane view from the Z-axis direction, the planar shape of the support frame 11 is not limited to a particular shape, and various shapes such as a polygonal ring shape, a circular ring shape, an elliptical ring shape, and the like can be adopted.

The support frame 11 contains zirconia (ZrO₂) and nickel oxide (NiO). Since the support frame 11 contains NiO having a thermal expansion coefficient higher than that of ZrO₂, the thermal expansion coefficient of the support frame 11 can be adjusted to a value between the thermal expansion coefficient of the cell body portion 10 and the thermal expansion coefficient of the metal separator 20. Therefore, the good connection between the cell body portion 10 and the separator 20 can be maintained. Specifically, in the present embodiment, it is possible to reduce the thermal stress generated in the bonding portions 30 interposed between the support frame 11 and the metal separator 20, thus making it possible to suppress cracking or peeling in the bonding portion 30.

Also, the porosity of the support frame after reduction treatment is 15% or less. As a result, the density of the support frame 11 after the reduction treatment can be maintained, so that it is possible to prevent gas leakage through the support frame 11. In the present specification, the “reduction treatment” refers to the process of holding the support frame 11 for 12 hours in a reducing atmosphere at 750° C. (e.g., an atmosphere of 100% H₂ gas humidified at 62° C.).

The porosity of the support frame after the reduction treatment can be adjusted by controlling the amount of NiO before the reduction treatment.

The porosity of the support frame after the reduction treatment is calculated by the following method. First, a cross section along the thickness direction of the support frame 11 after the reduction treatment is exposed. Next, a reflection electron image of the cross section of support frame 11 in 10000 times is obtained using an SEM equipment (FE-SEM JSM-7900F, manufactured by JEOL Ltd.). Next, portions displayed in black (corresponding to “pores”) in the reflection electron image are specified using HALCON, that is image analysis software manufactured by MVTec Software GmbH. Then, the porosity of the support frame 11 is calculated by dividing the total area of pores by the total area of the reflection electron image of the support frame 11.

Note that the porosity of the support frame before the reduction treatment is not particularly limited, but may be, for example, 10% or less.

The content of ZrO₂ in the support frame 11 after the reduction treatment is not particularly limited, but may be 40 mol % or more and 95 mol % or less. The content of NiO in the support frame 11 after the reduction treatment is not particularly limited, but may be from 5 mol % or more and 60 mol % or less.

Note that it is preferable that the support frame 11 after the reduction treatment has an electronic insulating property. This makes it possible to prevent short-circuiting from occurring between the cell body portion 10 and the metal separator 20.

The strength of the support frame 11 after the reduction treatment is preferably 140 MPa or more. This can prevent damage to the support frame 11 caused by stress applied when a plurality of separator-equipped electrolytic cells 1 are stacked. The strength of the support frame 11 after the reduction treatment can be adjusted by controlling the ratio of Ni in the support frame 11 and the particle size after firing.

The support frame 11 preferably further contains magnesium oxide (MgO). In a high-temperature environment, MgO is more soluble in NiO than ZrO₂, thus producing MgₓNi₍₁₋ₓ₎O, which is resistant to reduction. As a result, since the density of the support frame 11 can be maintained during operation of the electrolytic cell 2, the occurrence of gas leakage through the support frame 11 can be suppressed for a long period of time.

The support frame 11 preferably contains YSZ as ZrO₂. With this configuration, the strength of the support frame 11 after the reduction treatment can be further improved. The support frame 11 preferably contains, as ZrO₂, at least one of 3YSZ (3 mol % yttria stabilized zirconia) and 4YSZ (4 mol % yttria stabilized zirconia). As a result, the strength of the support frame 11 can be secured.

The thermal expansion coefficient of the support frame 11 after the reduction treatment is larger than that of the cell body portion 10 and smaller than that of the metal separator 20. The value of the thermal expansion coefficient of the support frame 11 is not particularly limited, but may be, for example, 11 ppm/K or more and 12.5 ppm/K or less. The thermal expansion coefficient of the support frame 11 can be adjusted by controlling the amount of Ni contained in the support frame 11.

The difference between the thermal expansion coefficient of the support frame 11 and the thermal expansion coefficient of the metal separator 20 after the reduction treatment is preferably 2.5 ppm/K or less. The difference between the thermal expansion coefficients is preferably 1.3 ppm/K or less, and more preferably, 0.7 ppm/K or less. As a result, thermal stress can be suppressed from occurring between the support frame 11 and the metal separator 20, and thus good connection between the cell body portion 10 and the separator 20 can be maintained.

The support frame 11 after the reduction treatment may contain a plurality of pores in its interior. In this case, the average circle-equivalent diameter of the plurality of pores is preferably 5 μm or less. As a result, leakage of the gas through the support frame 11 can be prevented.

The average circle-equivalent diameter of the plurality of pores can be obtained by arithmetically averaging the circle-equivalent diameter of the pores of 0.1 μm or more, specified in the reflection electron image used to calculate the porosity. The “circle-equivalent diameter of pore” means the diameter of a circle having the same area as pores.

The method for forming the support frame 11 is not particularly limited, and tape molding, screen printing, casting, dry pressing, or the like can be used.

### Metal Separator 20

The metal separator 20 is connected to the support frame 11 of the electrolytic cell 2 through the bonding portion 30. The metal separator 20 is electrically connected to the cell body portion 10 (specifically, the hydrogen electrode current collector layer 12) of the electrolytic cell 2 via the current collector member 25. The metal separator 20 has a connection portion 20a that is in contact with the current collector member 25.

As will be described later, the metal separator 20 is made of a metal material. The thermal expansion coefficient of the metal separator 20 is larger than that of the cell body portion 10. The value of the thermal expansion coefficient of the metal separator 20 is not particularly limited, but for example, 11.5 ppm/K or more and 13.5 ppm/K or less.

The metal separator 20 is made of a metal material having electronic conductivity. The metal separator 20 can be made of, for example, an alloy material containing Cr (chromium). Examples of such an alloy material include Fe—Cr alloy steel (e.g., stainless steel) and Ni—Cr alloy steel. The content of Cr in the metal separator 20 is not particularly limited, but may be 4 mass % or more and 30 mass % or less.

The metal separator 20 may also contain Ti (titanium) or Zr (zirconium). The content of Ti in the metal separator 20 is not particularly limited, but may be 0.01 mol % or more and 1.0 mol % or less. The content of Al in the metal separator 20 is not particularly limited, but may be 0.01 mol % or more and 0.4 mol % or less. The metal separator 20 may contain Ti in the form of TiO₂ or may contain Zr in the form of ZrO₂ (zirconia).

The metal separator 20 may have, on its surface, an oxide film formed by oxidation of constituent elements of the metal separator 20. A typical example of the oxide film is a chromium oxide film. The chromium oxide film covers at least a portion of the surface of the metal separator 20.

### Current Collector Member 25

The current collector member 25 electrically connects the hydrogen electrode current collector layer 12 and the metal separator 20. As shown in FIG. 1, the current collector member 25 is disposed in the space S1 between the hydrogen electrode current collector layer 12 and the metal separator 20. The current collector member 25 is in contact with the first main surface 12a of the hydrogen electrode current collector layer 12 and the connection portion 20a of the metal separator 20.

The current collector member 25 has electronic conductivity and air permeability. As the current collector member 25, for example, a member made of nickel, a nickel alloy, stainless steel, or the like can be used. The size, shape, and position of the current collector member 25 can be changed as appropriate. For example, in the present embodiment, the current collector member 25 is in contact with both the hydrogen electrode current collector layer 12 and the support frame 11, but does not need to be in contact with the support frame 11.

### Bonding Portion 30

The bonding portion 30 positions the support frame 11 with respect to the metal separator 20. The bonding portion 30 is a dense body. The bonding portion 30 seals a gap between the electrolytic cell 2 and the metal separator 20. This prevents gases from leaking through the gap between the electrolytic cells 2 and the metal separator 20.

The bonding portion 30 preferably has electronic insulating properties. This makes it possible to prevent the occurrence of a short circuit between the cell body portion 10 and the metal separator 20.

The bonding portion 30 can be formed of, for example, glass, glass ceramics (crystallized glass), or a composite of glass and ceramics.

### Variations of Embodiments

Although the embodiments of the present invention have been described thus far, the present invention is not limited thereto, and various variations can be made without departing from the gist of the present invention.

### Variation 1

In the above embodiment, the electrolytic cell is a so-called cathode support type cell, but may be a so-called electrolytic support type cell or a so-called anode support type cell. If the electrolytic cell is an electrolytic support type cell, the support frame 11 surrounds the electrolyte layer 14. If the electrolytic cell is an anode support type cell, the support frame 11 surrounds the oxygen electrode layer 16.

### Variation 2

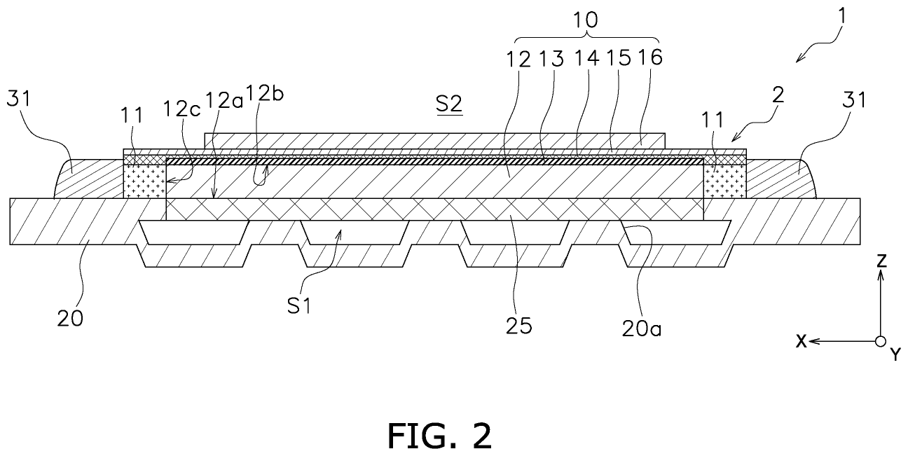

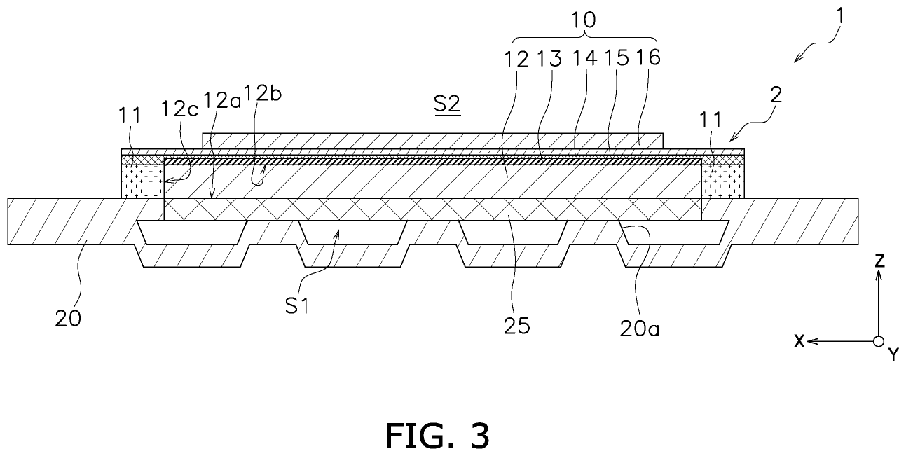

In the above embodiment, the support frame 11 is connected to the separator 20 via the bonding portion 30, but the support frame 11 may be in contact with the metal separator 20. For example, as shown in FIG. 2, the support frame 11 may be placed directly on the separator 20 and fixed to the separator 20 by a sealing portion 31 which surrounds the outer periphery of the support frame 11. Alternatively, as shown in FIG. 3, the support frame 11 may be directly bonded to the separator 20 by heat treatment while the support frame 11 is directly placed on the metal separator 20.

### Variation 3

In the above embodiment, the hydrogen electrode active layer 13 functions as a cathode and the oxygen electrode layer 16 functions as an anode, but the hydrogen electrode active layer 13 may function as an anode and the oxygen electrode layer 16 may function as a cathode. In this case, the constituent materials of the hydrogen electrode active layer 13 and the oxygen electrode layer 16 are exchanged, and the source gas is caused to flow on the outer surface of the hydrogen electrode active layer 13. The hydrogen electrode current collector layer 12 functions as an oxygen electrode current collector layer, while the configuration and function of the oxygen electrode current collector layer are the same as the configuration and function of the hydrogen electrode current collector layer 12 described in the above embodiment.

### Variation 4

In the above embodiment, the electrolytic cell 2 has been described as an example of the electrochemical cell, but the electrochemical cell is not limited to the electrolytic cell. An electrochemical cell is a general term for an element in which a pair of electrodes are arranged so that an electromotive force is generated from an overall oxidation reduction reaction in order to convert electric energy into chemical energy, and an element for converting chemical energy into electric energy. Accordingly, the electrochemical cell includes, for example, a fuel cell using oxide ions or protons as carriers.

1. An electrochemical cell to be connectable to a metal separator, the electrochemical cell comprising:
a cell body portion including a current collector layer, a first electrode layer disposed on the current collector layer, a second electrode layer, and an electrolyte layer disposed between the first electrode layer and the second electrode layer; and
an annular support frame configured to be connectable to the metal separator and surrounding at least a portion of the cell body portion, wherein
the support frame contains zirconia and nickel oxide, and
a porosity of the support frame after a reduction treatment at 750° C. for 12 hours is 15% or less.

2. The electrochemical cell according to claim 1, wherein
a strength of the support frame after the reduction treatment is 140 MPa or more.

3. The electrochemical cell according to claim 1, wherein
the support frame further contains magnesium oxide.

4. The electrochemical cell according to claim 1, wherein
the support frame contains at least one of 3YSZ and 4YSZ as zirconia.

5. The electrochemical cell according to claim 1, wherein
a difference between a thermal expansion coefficient of the support frame and a thermal expansion coefficient of the metal separator after the reduction treatment is 2.5 ppm/K or less.

6. The electrochemical cell according to claim 1, wherein
the support frame after the reduction treatment has a plurality of pores; and
the plurality of pores have an average circle equivalent diameter of 5 μm or less.

7. A separator-equipped electrochemical cell, comprising:
the electrochemical cell according to claim 1; and
a metal separator connected to the support frame.
